(19) United States
(12) Patent Application Publication
(10) Pub. No.: US 2016/0183651 A1
(43) Pub. Date: Jun. 30, 2016

(54) PORTABLE CONTAINER, SUCH AS A SUITCASE, TROLLEY CASE, TRUNK AND THE LIKE, AND ASSOCIATED ACCESSORY

(71) Applicant: G.T. LINE S.R.L., Crespellano (IT)

(72) Inventor: Massimo TONELLI, Casalecchio Di Reno (IT)

(21) Appl. No.: 14/909,709

(22) PCT Filed: Aug. 2, 2013
(86) PCT No.: PCT/IT2013/000219

§ 371 Date: Feb. 2, 2016

(51) Int. Cl. A45C 13/02; B25H 3/06; B25H 3/02; A45C 5/03; A45C 5/14

(52) U.S. Cl. CPC A45C 13/02; A45C 5/03; A45C 5/14; B25H 3/02; B25H 3/06; A45C 2005/037; A45C 2013/026

(57) ABSTRACT

A portable container, such as a suitcase, trolley case, trunk and the like, includes at least one shell, which delimits an internal compartment for accommodating tools, utensils, clothes and objects in general. The container includes at least one tray that can be arranged stably inside the shell and can be extracted selectively to move easily and practically objects contained in the tray, even at a distance from the shell.

### TECHNICAL FIELD

The present disclosure relates to a portable container, such as a suitcase, trolley case, trunk and the like, and to an associated accessory.

### BACKGROUND

Various types of portable containers, such as for example trunks, suitcases, trolley cases etcetera, are currently commercially widespread.

Usually, as is known, they comprise a rigid or semirigid box-shaped to shell (usually constituted by two mutually articulated half-shells), which forms on the inside a compartment adapted to accommodate clothing, personal items and objects of various kinds.

The dimensions, materials and colors may be different according to the specific requirements, and it is likewise easy to find on the market solutions that offer the consumer additional particularities, such as for example the capacity to withstand even violent impacts, waterproofness, extremely low weight, etcetera, both to meet specific functional requirements and simply to try to distinguish themselves from similar products of competitors and thus gain competitive advantages on the market.

Moreover, the internal compartment of the container, especially in the case of suitcases or trolley cases, is often provided with pockets, partitions, retention elements of various kinds, which allow separating and accommodating tidily the objects stored in the container.

However, especially for activities of a professional type, to be carried out in specific locations and with the aid of specific tools (for example for assemblies, maintenance operations, periodic checks, etcetera), after bringing the container on site sometimes the need is felt to be able to remove from the container entire kits of said tools or utensils (or in any case a predefined quantity thereof) so as to have them available in a more practical manner during the required professional activity.

Moreover, when the user anticipates an activity that is different from the one performed previously, he must also be able to replace the kits with others that contain the tools and utensils that are specific to the new task.

It is therefore evident that the constructive solutions described above are completely unsuitable for the applications mentioned above, since they force the user to perform the complete and obviously inconvenient emptying and/or filling of the container whenever it is necessary to transfer entire kits of objects, due to the reasons described above.

The aim of the present disclosure is to solve the problems described above, providing a portable container, such as a suitcase, trolley case, trunk and the like, that allows in a practical manner the extraction and insertion of a predefined plurality of objects.

### SUMMARY

Within this aim, the disclosure provides an accessory for portable containers, such as suitcases, trolley cases, trunks and the like, that allows in a practical manner the extraction and insertion of a predefined plurality of objects.

The disclosure further provides a portable container that allows in a practical manner the extraction and insertion of a predefined plurality of objects, ensuring their optimum and stable transport so long as they are accommodated therein.

The disclosure also provides a portable container that ensures high reliability in operation.

The disclosure further provides a portable container and a corresponding accessory that can be obtained easily starting from commonly commercially available elements and materials.

The disclosure also provides a portable container and a corresponding accessory that have a low cost and are safe in application.

These aims are achieved by a portable container, such as a suitcase, trolley case, trunk and the like, which comprises at least one shell, which delimits an internal compartment for accommodating tools, utensils, clothes and objects in general, characterized in that it comprises at least one tray that can be arranged stably inside said shell and can be extracted selectively to move easily and practically objects contained in said at least one tray, even at a distance from said shell.

These aims are also achieved by an accessory for containers, such as a suitcase, trolley case, trunk and the like, comprising at least one shell, which delimits an internal compartment for accommodating tools, utensils, clothes and objects in general, characterized in that it is constituted substantially by a tray provided with means for detachable coupling to the shell, for stable placement within the compartment and for extraction of said tray, with consequent practical and easy movement of objects contained in said tray even at a distance from the shell.

### BRIEF DESCRIPTION OF THE DRAWINGS

Further characteristics and advantages of the disclosure will become more apparent from the description of a preferred but not exclusive embodiment of the portable container and the corresponding accessory according to the disclosure, illustrated by way of non-limiting example in the accompanying drawings, wherein:

FIG. 1 is a lateral front perspective view of the portable container according to the disclosure;

FIG. 2 is a front elevation view of the portable container according to the disclosure;

FIG. 3 is a sectional view of FIG. 2, taken along the plane III-III;

FIG. 4 is a top view of the portable container according to the disclosure;

FIG. 5 is a sectional view of FIG. 4, taken along the plane V-V;

FIGS. 6 to 9 are lateral front perspective views of the accessory according to the disclosure in various conditions of use;

FIG. 10 is a highly enlarged-scale perspective view of some components of the accessory according to the disclosure;

FIG. 11 is a lateral rear perspective view of the accessory according to the disclosure without the components of FIG. 10.

### DETAILED DESCRIPTION OF THE DRAWINGS

With particular reference to the cited figures, the reference numeral 1 generally designates a portable container, such as a suitcase, trolley case, trunk and the like, which comprises at least one shell 2, which delimits an internal compartment 2a, in which it is possible to accommodate tools, utensils, clothes and objects in general.

More precisely, in the preferred application, to which constant reference shall be made hereinafter, the container 1 is a trolley case or a trunk, made of non-deformable material and preferably used for activities of a professional kind (assemblies, maintenance operations, periodic checks, etcetera), for which it is necessary to have available specific utensils or tools, which can thus be accommodated in the internal compartment 2a of the shell 2 in ways that will be described hereinafter.

The disclosed embodiments provide the use of containers 1 of a different type, both for professional use and simply for travel or leisure trips.

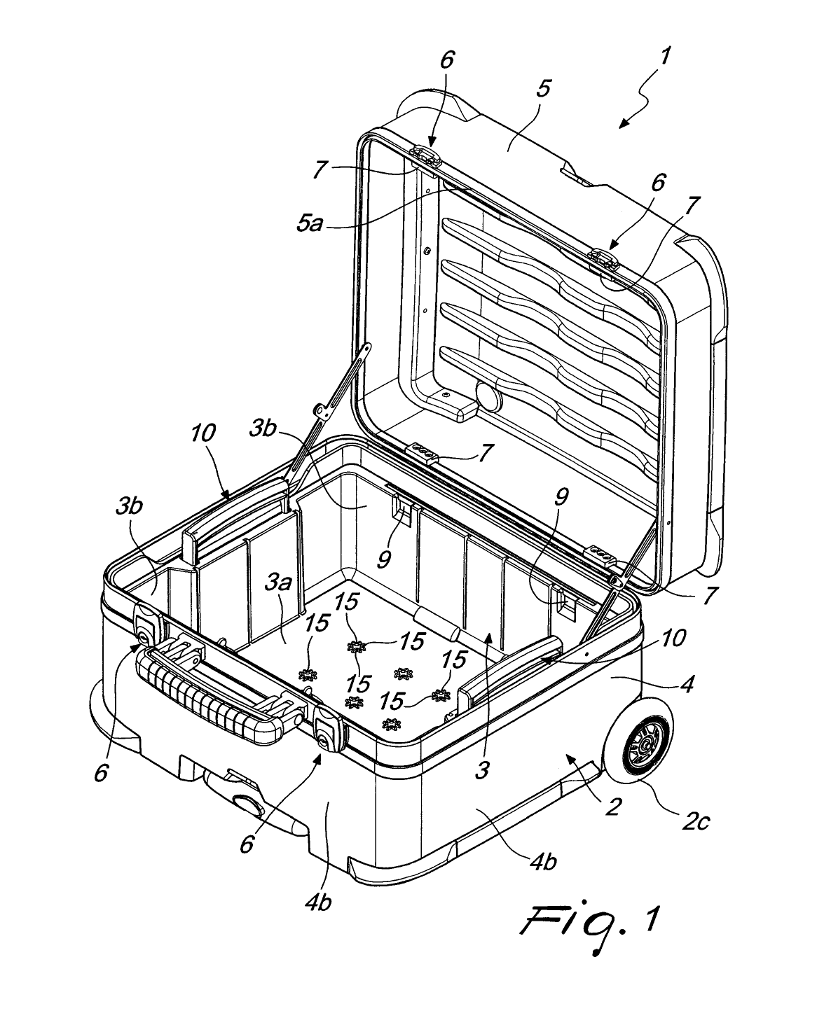

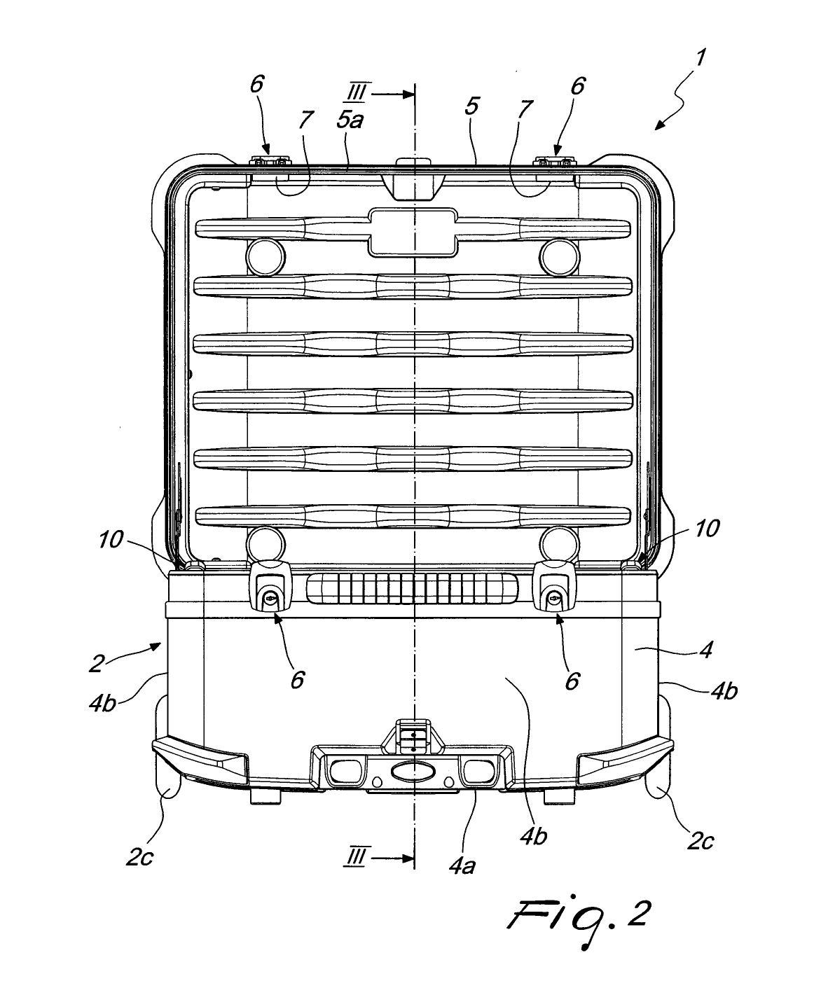

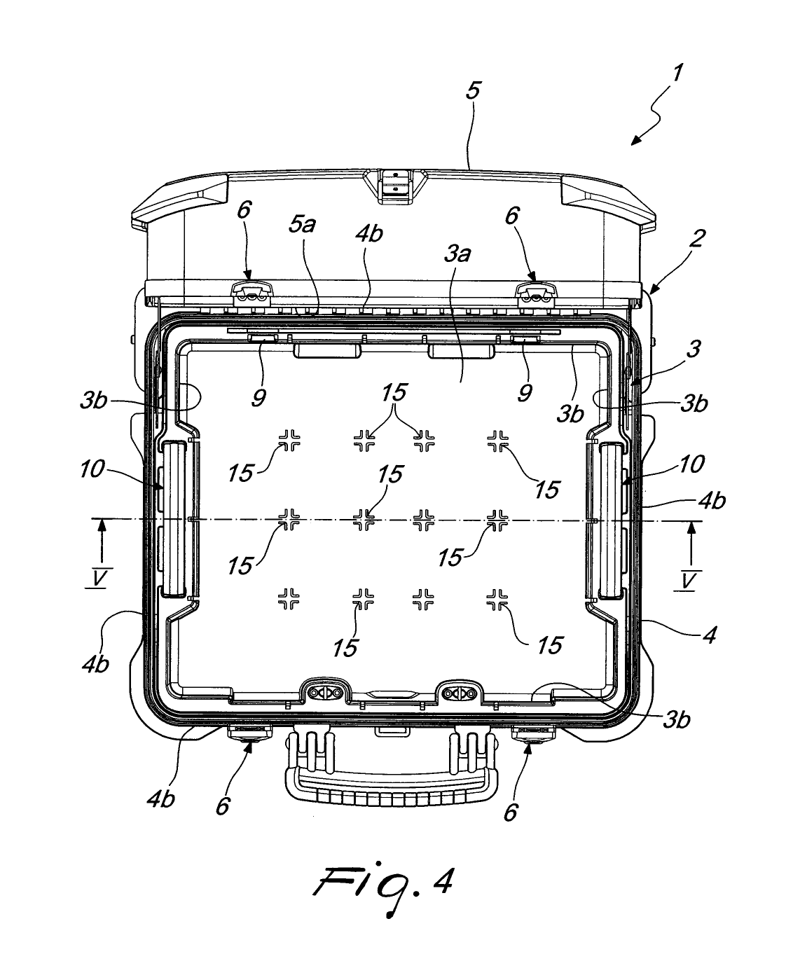

According to the disclosure, the container 1 comprises at least one tray 3, which can be arranged in a stable manner inside the shell 2 (such as for example in FIGS. 1 to 5) and can be extracted selectively in order to move in a practical and easy manner objects of any kind (tools, utensils, clothes, etcetera) contained in said tray 3, even at a distance from the shell 2.

In particular, according to an embodiment of considerable practical interest, mentioned by way of non-limiting example of the application of the disclosure, the shell 2 comprises a first half-shell 4 and a second half-shell 5, which are mutually articulated and can move between a completely open configuration (in which the container 1 is shown in FIGS. 1 to 5), to allow picking up objects from the internal compartment 2a (or store them therein), and a closed configuration, in which adapted locks 6 (and optional padlocks) ensure the inaccessibility of the internal compartment 2a.

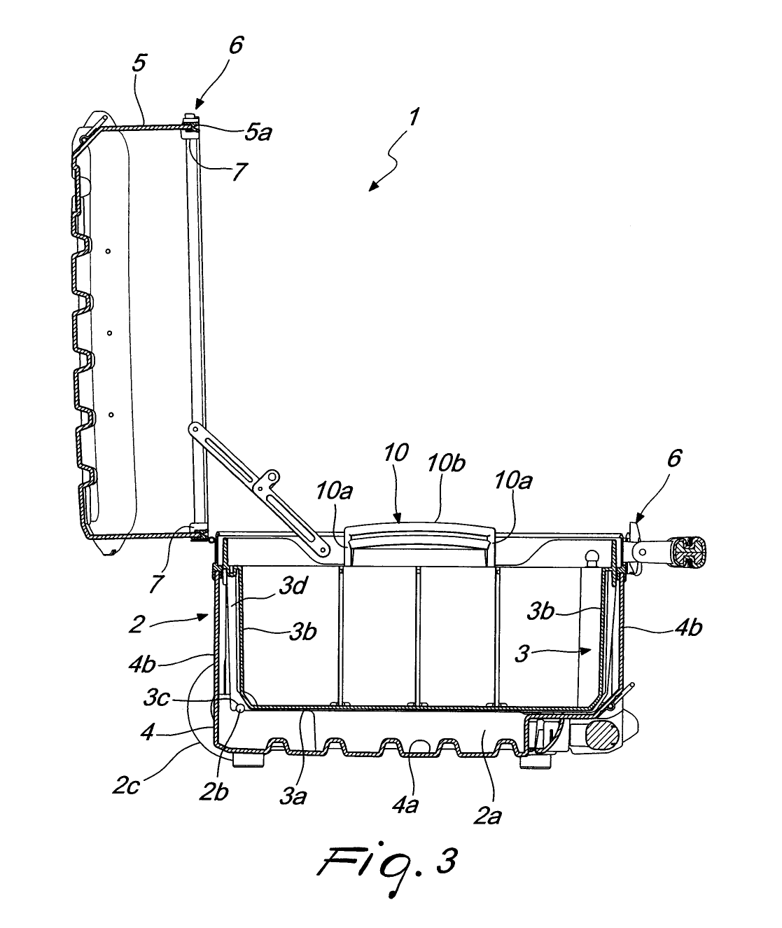

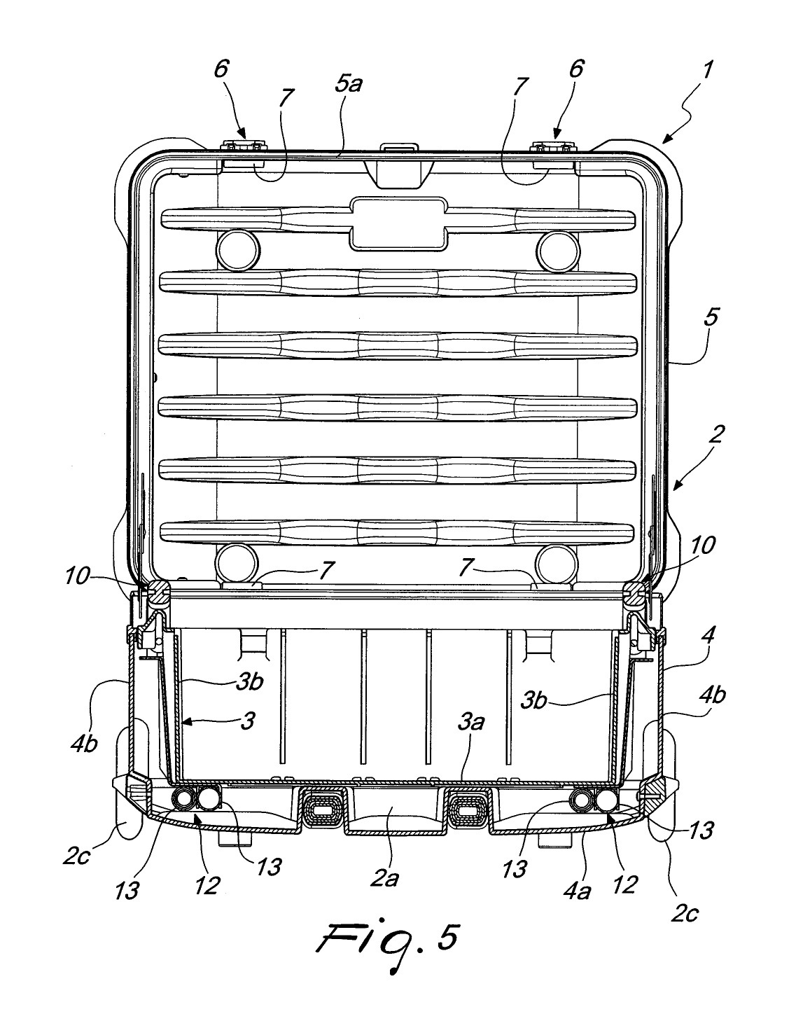

In this embodiment, which does not limit the application of the disclosure, the tray 3 comprises a base surface 3a, which is arranged so as to face in a parallel manner, and be contiguous to, a bottom face 4a of the first half-shell 4 when the tray 3 is arranged in the shell 2 (as can be seen for example in FIGS. 3 and 5). Furthermore, the tray 3 comprises four side walls 3b, which are perpendicular to the base surface 3a and respectively face, and are arranged parallel to, four lateral faces 4b of the first half-shell 4 when the tray 3 is arranged in the shell 2.

More particularly, the base surface 3a of the tray 3 has a shape and dimensions that are complementary to the shape and dimensions of the bottom face 4a of the first half-shell 4: thus, when the tray 3 is arranged in the shell 2, each side wall 3b abuts against a respective lateral face 4b of the first half-shell 4, hindering the sliding of the base surface 3a (and of the tray 3) with respect to the bottom face 4a (and the first half-shell 4) and thus preventing unwanted movements of the tray 3.

Conveniently, the portable container 1 according to the disclosure comprises means for the detachable coupling of the tray 3 to the shell 2, in order to ensure the stable accommodation of said tray 3 in the internal compartment 2a of the shell 2. In particular, the means for detachable coupling comprise a plurality of mutually aligned recesses 3c (as can be seen in FIG. 11), which are formed along end portions of ribs 3d that protrude externally from one of the side walls 3b of the tray 3. When the tray 3 is arranged in the shell 2, it is thus possible to insert a shaft 2b at least partially into said recesses 3c, which shaft supports rotatably wheels 2c of the shell 2. The coupling thus provided between the shaft 2b and the recesses 3c hinders further the sliding of the base surface 3a with respect to the bottom face 4a (contributing to the coupling ensured by the above-described choice of providing the base surface 3a and the bottom face 4a with mutually complementary shapes and dimensions).

This additional obstacle is thus obtained without providing the container 1 with additional components but simply by providing the tray 3 with appropriately shaped ribs 3d and by utilizing the shaft 2b that is already preset to support wheels 2c (usually provided in containers, even of a known type, in order to make it easier to move them).

However, the possibility is not excluded of providing detachable coupling means of a different type and in any case capable of hindering the sliding of the base surface 3a with respect to the bottom face 4a. More generally, in fact, the coupling means can comprise a contoured crest, which protrudes from the bottom face 4a to enter at least partially, when the tray 3 is arranged in the shell 2, a respective slot of complementary shape provided along the base surface 3a of the tray 3 (in a manner that is similar, therefore, to what has been observed for the shaft 2b that enters the recesses 3c).

Moreover, the detachable coupling means can comprise at least one respective retention element 7, which protrudes internally from the edge 5a of the second half-shell 5; in the solution proposed in the accompanying figures by way of non-limiting example, along the edge 5a of the second half-shell 5 there are four retention elements 7 that are mutually opposite in pairs, but the possibility is not excluded, of providing the container 1 with a larger or smaller number of retention elements 7 as a function of the specific requirements.

In any case, in the closed configuration of the shell 2, with the tray 3 arranged therein, each retention element 7 abuts against the top of a corresponding side wall 3b of the tray 3, thus preventing any movement of the tray 3 at right angles to the base surface 3a (i.e., along the direction of insertion and extraction of the tray 3).

Thanks to the retention elements 7, which move automatically into abutment on the side walls 3b of the tray 3 when the shell 2 is in the closed configuration, the danger of jolts of said tray 3 and of the objects contained therein during the transport of said container 1 is thus avoided.

Moreover, as can be seen for example in FIG. 1, two of the four retention elements 7 are arranged substantially at the locks 6: thus, by operating on the locks 6 (for example by means of a key), in order to ensure the stable closure of the shell 2, it is possible at the same time to force the respective retention elements 7 into abutment against the corresponding side wall 3b of the tray 3, contributing to the stability of the latter.

It should also be noted that the coupling ensured by retention elements 7 is deactivated automatically as soon as the second half-shell 5 is rotated (and the retention elements 7 are thus spaced from the side walls 3b), moving the shell 2 to a fully open (or partially open) configuration, thus allowing in a practical manner the extraction and subsequent reinsertion of the tray 3.

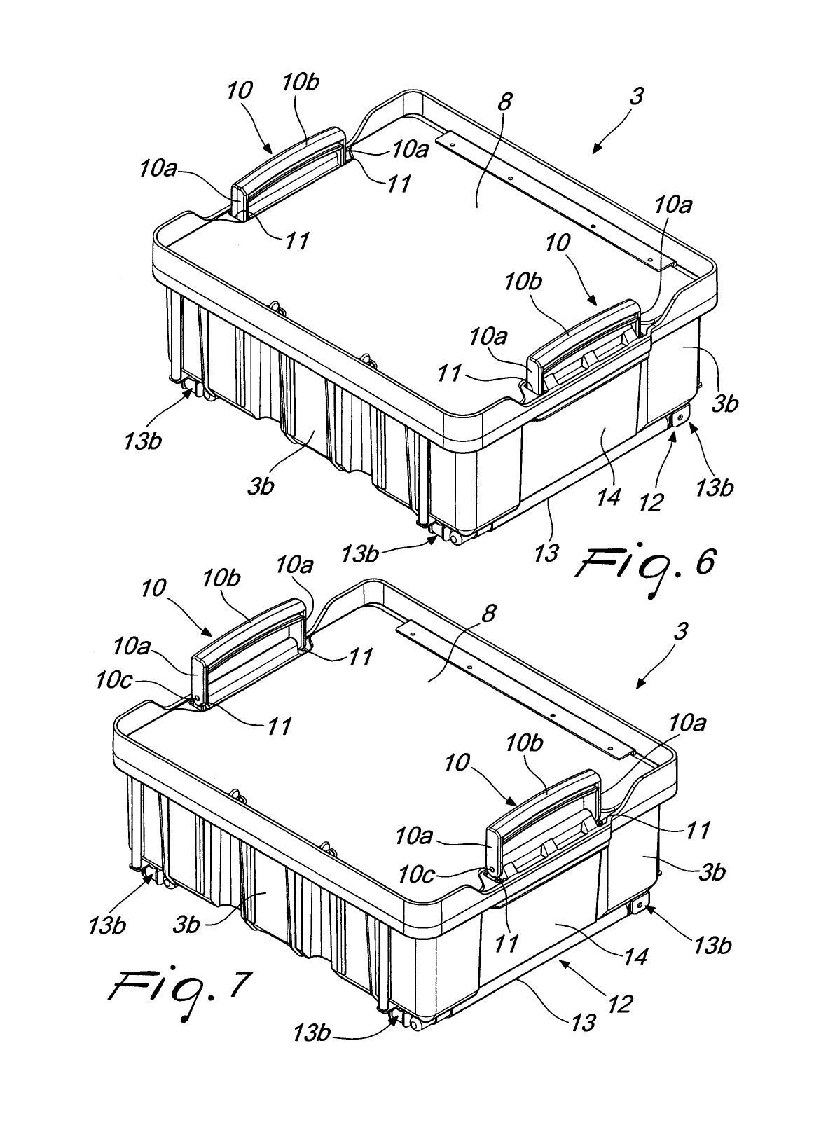

Positively, as shown in FIGS. 6 and 7, the container 1 can comprise a panel 8, arranged detachably so as to close the tray 3, on the side opposite to the base surface 3a.

The panel 8 can be simply rested on the top of the side walls 3b of the tray 3 or be coupled thereto in various ways, by means of respective components provided adequately (and by utilizing for example slots 9 provided for this purpose along one or more side walls 3b), as a function of the specific requirements.

Conveniently, the portable container 1 according to the disclosure comprises at least one handle 10, which is arranged substantially at at least one top of at least one of the side walls 3b, on the side opposite to the base surface 3a, in order to allow a user to extract and move easily the tray 3 and the objects contained therein.

In particular, in the constructive solution proposed merely by way of example in the accompanying figures, the portable container 1 comprises two handles 10, which are arranged on the top of respective mutually opposite side walls 3b.

Each handle 10 can move between a first configuration of minimum space occupation, in which it is contained at least partially in a respective recess 11 (as in FIG. 6) provided along the corresponding side wall 3b, and a second configuration for movement, in which it is at least partially extracted from the respective recess 11 (as in FIG. 7) in order to be gripped easily by the user, and vice versa.

More particularly, each handle 10 is constituted substantially by a U-shaped bracket, which comprises two arms 10a that are mutually parallel and can move in the respective recesses 11; the arms 10a are interconnected, at respective first ends, by a crossmember 10b that can be gripped by the user.

On the side opposite to the crossmember 10b, the arms 10a are interconnected by a pivot 10c, which can slide in a respective guide provided along the respective side wall 3b, in order to allow the handle 10 to pass from the first configuration to the second configuration and vice versa.

It should also be noted that when each handle 10 is in the position shown in FIG. 7, i.e., substantially completely extracted from the respective recess 11, it can oscillate about the axis of the corresponding pivot 10c, allowing an easier grip for the user.

Advantageously, the portable container 1 according to the disclosure comprises means 12 for the stable support of the tray 3, which can be actuated selectively following the extraction of said tray 3 from the shell 2, to thus ensure the support of the tray 3 even when it is at a distance from the shell 2.

In particular, in the preferred constructive solution, proposed in the accompanying figures by way of non-limiting example of the application of the disclosure, the supporting means 12 comprise a plurality of telescopic supporting stems 13, which are coupled to the tray 3: for example, each stem 13 can be constituted by a plurality of segments 13a that can slide coaxially inside each other so as to be able to vary the overall length of said stem 13.

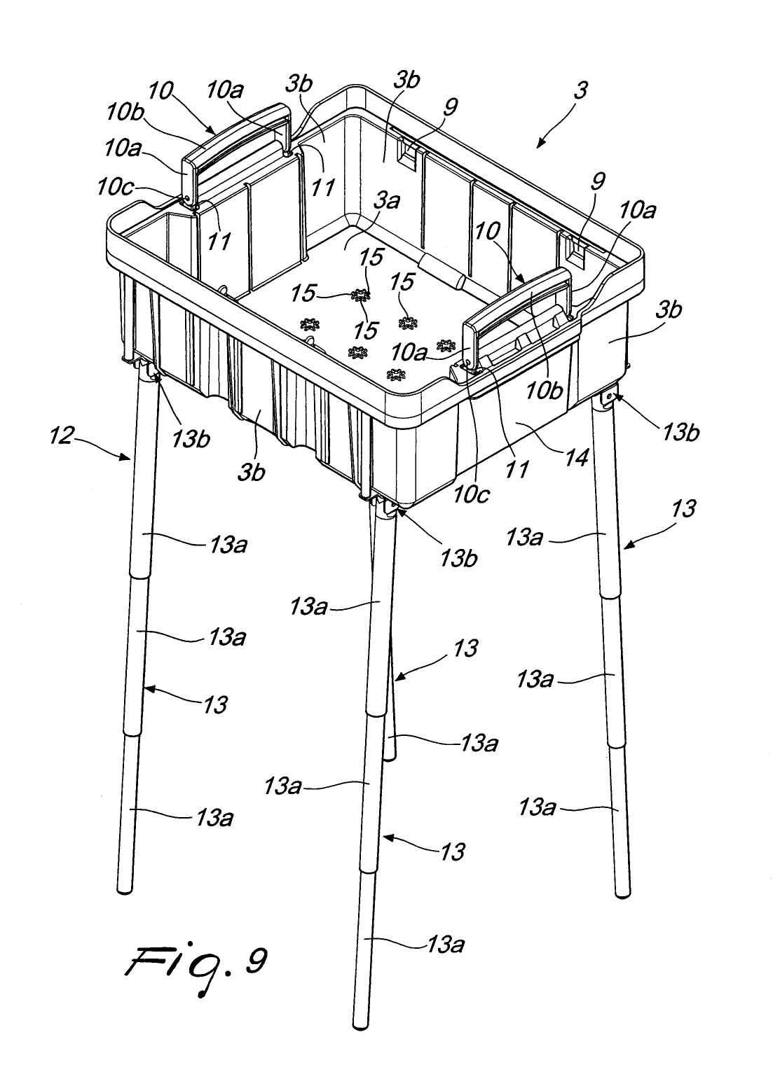

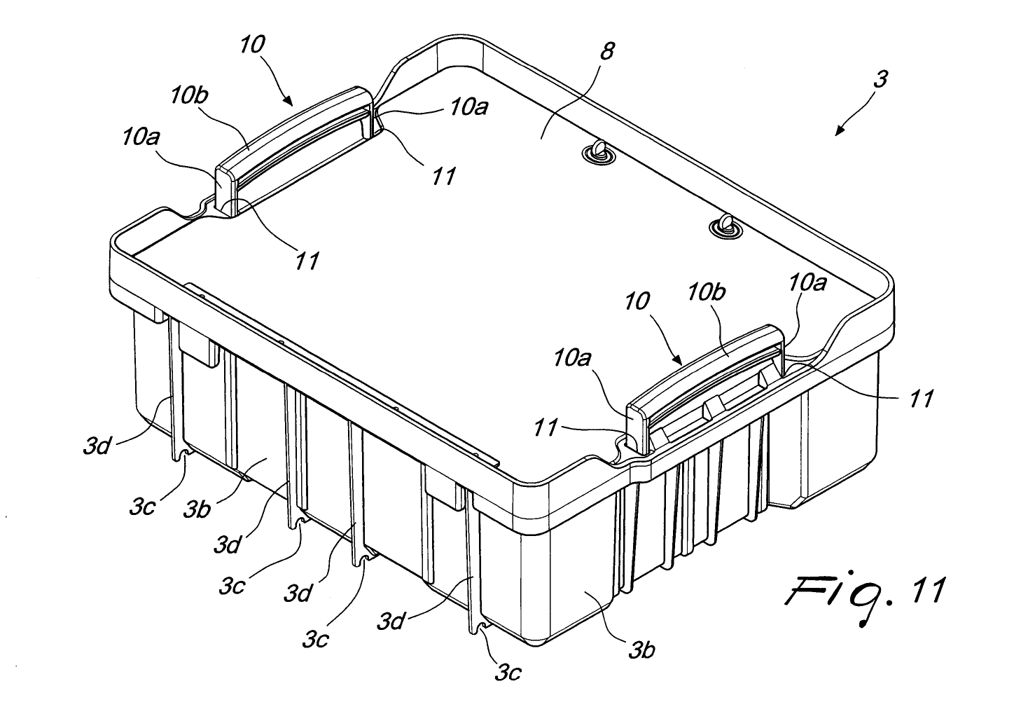

Each stem 13 can thus move between a first arrangement (shown in FIGS. 6 to 8), in which it has the minimum length and faces and is proximate to the base surface 3a, so as to contain the overall space occupation and allow the placement of the tray 3 in the shell 2, and a second arrangement (shown in FIG. 9), in which each stem 13 is rotated with respect to the first arrangement and has a maximum length, so as to form a support for the tray 3, extracted from the shell 2, while it is also raised from the ground (thus allowing the user a more practical access to its contents).

For coupling the stems 13 to the tray 3, allowing at the same time the rotation of each one of them from the first arrangement to the second arrangement and vice versa, the supporting means 12 comprise a pair of fixing plates 14, which are applied to respective mutually opposite side walls 3b of the tray 3: each plate 14 supports rotatably a pair of telescopic stems 13 that are pivoted thereto at an end portion 13b of one of said segments 13a.

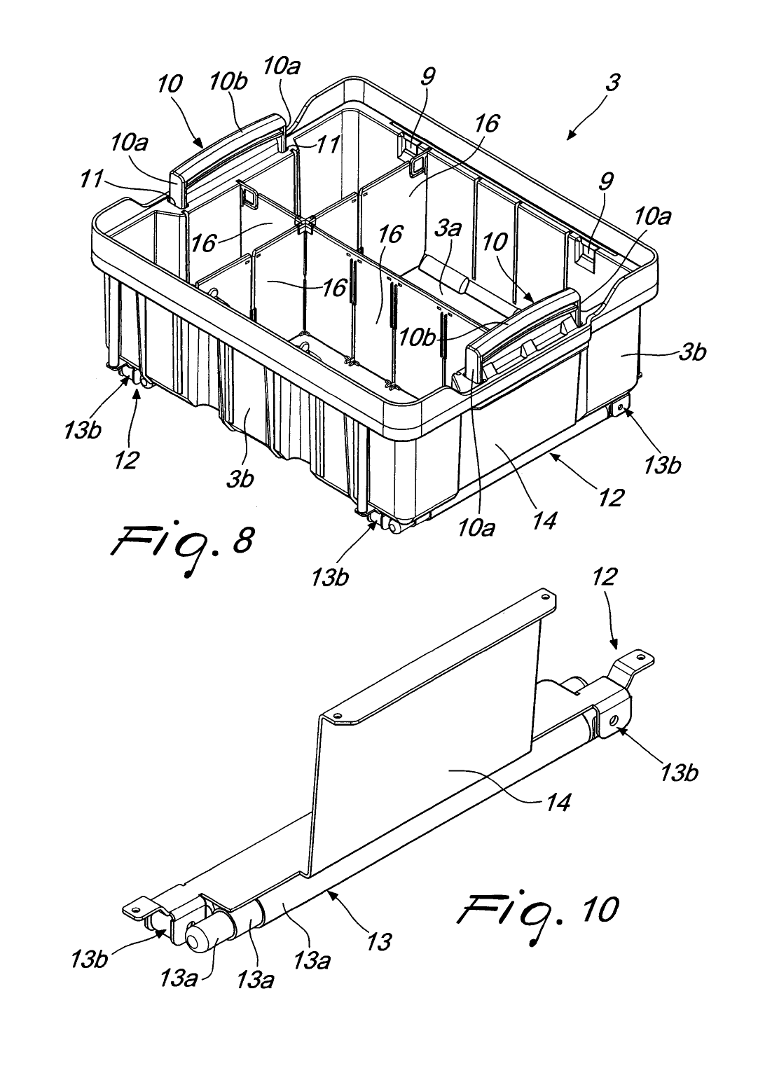

Favorably, the tray 3 has a plurality of raised portions 15, which are distributed over the internal surface of the base surface 3a so as to form respective seats for corresponding partitions 16 that can be inserted in the tray 3 (as can be seen in FIG. 8) in order to divide the internal space into two or more compartments as a function of the specific requirements.

The present description therefore relates also to an accessory for containers, such as a suitcase, trolley case, trunk and the like, which comprise in any case at least one shell 2, which delimits an internal compartment 2a in which it is possible to accommodate tools, utensils, clothes and objects in general.

The accessory according to the disclosure is constituted substantially by a tray 3, which is provided with means for detachable coupling to the shell 2: in this manner, the tray 3 can be arranged stably within the compartment 2a and be extracted from it (and subsequently reinserted) when needed, in order to allow consequently a practical and easy movement of objects contained in the tray 3 even at a distance from the shell 2.

The use of the container and of the accessory according to the disclosure is as follows.

When the two half-shells 4, 5 are mutually fastened in the closed configuration, the container 1 can be transported, also according to known methods, and it is possible to move with it objects, personal items, clothes, etc., contained in the internal compartment 2a, which can be accessed simply by opening the shell 2 (lifting and rotating the second half-shell 5 with respect to the first half-shell 4).

The tray 3, as has been shown, can be arranged within the compartment 2a, and objects of any type can thus be stored therein and are thus moved together with the container 1.

In this closed configuration, the choice to provide the base surface 3a of the tray and the bottom face 4a of the first half-shell 4 with mutually complementary shapes and dimensions, together with the detachable coupling means, ensure that the tray 3 does not move with respect to the shell 2, avoiding the danger of oscillations, jolts, etcetera during the transport of the container 1 according to the disclosure and thus ensuring optimum and stable transport of the objects (for example tools, utensils, etcetera) so long as they are accommodated in said tray 3.

When one wishes to use the objects contained in the tray 3, after of course moving the shell 2 to the fully (or partially) open position, it is possible first of all simply to extract the objects from the tray 3 while said tray is kept inside the first half-shell 4.

Favorably, and in particular if the objects (for example, indeed, tools and utensils) are required in order to perform activities of a professional type (such as assemblies, maintenance operations, periodic checks, etcetera) in predefined locations, the user can grip the handles 10 and extract the entire tray 3 (and its contents) to place it thus in the position that is most suitable to him (even at a distance from the shell 2) with respect to the specific working location and the task that he is about to perform.

In this manner it is very practical and easy for the user to have available entire kits of tools or utensils (or in any case a predefined quantity thereof) during the required professional activity, since he can simply extract the tray 3 (and subsequently reinsert it in the first half-shell 4) instead of having to repeat this action for each tool of interest.

Furthermore, if one wishes to resort to the portable container 1 for various professional activities (and not only professional ones) that are mutually different, it is sufficient to provide a plurality of trays 3, each containing a different kit, in order to ensure that the user can modify quickly the entire content of the tray 3 (and therefore of the container 1 according to the disclosure).

It should be noted, furthermore, that the telescopic supporting stems 13 (and more generally the stable supporting means 12) ensure an effective support for the tray 3 when it is separated from the shell 2, whereas when the tray 3 is arranged in the first half-shell 4 said stems can be rotated into the first arrangement, having a minimum space occupation and thus being accommodated conveniently in the space comprised between the bottom face 4a and the base surface 3a.

In practice it has been found that the container and the corresponding accessory according to the disclosure achieve fully the intended aim, since the choice to resort to a tray that can be arranged stably within the shell and can be extracted selectively in order to allow the practical and easy movement of objects contained in said tray, even at a distance from shell, ensures in a practical manner the extraction and insertion of a predefined plurality of objects.

The disclosure thus conceived is susceptible of numerous modifications and variations; all the details may further be replaced with other technically equivalent elements.

For example, by way of illustration of a possible variation of application, it is noted that the container 1 according to the disclosure can be intended for applications in the field of cosmetics, makeup and hair styling. For this purpose, it is possible to provide the tray 3 with a set of mirrors (for example as a replacement of the panel 8), optionally provided with lights and/or elements capable of keeping it in a vertical configuration.

In the exemplary embodiments shown, individual characteristics, given in relation to specific examples, may actually be interchanged with other different characteristics that exist in other exemplary embodiments.

In practice, the materials used, as well as the dimensions, may be any according to the requirements and the state of the art.

1-15. (canceled)

16. A portable container comprising at least one shell, which delimits an internal compartment for accommodating a plurality of objects, further comprising at least one tray that can be arranged stably inside said shell and can be extracted selectively to move easily and practically objects contained in said at least one tray, even at a distance from said shell.

17. The portable container according to claim 16, wherein said shell comprises a first half-shell and a second half-shell, which are mutually articulated and can move between an open configuration and a closed configuration, said tray comprising a base surface, which faces and is parallel to a bottom face of said first half-shell when said tray is arranged in said shell, and four side walls, which are perpendicular to said base surface and respectively face and are parallel to four lateral faces of said first half-shell when said tray is arranged in said shell.

18. The portable container according to claim 17, wherein said base surface of said tray has a tray shape and a plurality of tray dimensions that are complementary to a shell shape and a plurality of shell dimensions of said bottom face of said first half-shell, each one of said side walls abutting against a respective lateral face when said tray is arranged in said shell, in order to hinder the sliding of said base surface with respect to said bottom face.

19. The portable container according to claim 16, further comprising means for detachably coupling said tray to said shell, for the stable accommodation of said tray.

20. The portable container according to claim 19, wherein said coupling means include a plurality of mutually aligned recesses, which are formed along end portions of ribs that protrude externally from one of said side walls of said tray, when said tray is arranged in said shell a shaft, which supports rotatably wheels of said shell, being able to be at least partially inserted into said recesses, for further hindrance to the sliding of said base surface with respect to said bottom face.

21. The portable container according to claim 19, wherein said detachable coupling means include at least one respective retention element, which protrudes internally from the edge of said second half-shell, in said closed configuration of said shell, when said tray is arranged in said shell, said at least one retention element abutting against the top of at least one corresponding side wall of said tray.

22. The portable container according to claim 16, further comprising a panel, which is arranged detachably so as to close said tray on a side opposite to said base surface.

23. The portable container according to claim 21, further comprising at least one handle, which is arranged substantially at at least one of said tops of at least one of said side walls, on the side opposite to said base surface, for easy extraction and movement of said tray and of the objects contained therein.

24. The portable container according to claim 23, further comprising two of said handles, arranged on said tops of respective side walls, which are mutually opposite, each one of said handles being movable between a first configuration for minimum space occupation, in which it is contained at least partially in a respective recess, provided along said corresponding side wall, and a second configuration for movement, in which it is at least partially extracted from said respective recess, and vice versa.

25. The portable container according to claim 24, wherein each one of said handles is substantially constituted by a U-shaped bracket that comprises two mutually parallel arms that can move in said respective recesses, said arms being interconnected, at respective first ends, by a crossmember that can be gripped by the user, on the side opposite to said crossmember said arms being interconnected by a pivot, which can slide in a respective guide provided along said respective side wall, for transition from said first configuration to said second configuration and vice versa.

26. The portable container according to claim 16, further comprising means for the stable support of said tray, which can be actuated selectively following an extraction of said tray from said shell, in order to support said tray, at a distance from said shell.

27. The portable container according to claim 26, wherein said supporting means comprise a plurality of telescopic supporting stems, which are coupled to said tray, each one of said stems being movable between a first arrangement, in which it has a minimum length and faces and is proximate to said base surface, to contain the space occupation of said tray in said shell and place it therein, and a second arrangement, in which each one of said stems is rotated with respect to said first arrangement and has a maximum length, for the stable support of said tray, which is extracted from said shell.

28. The portable container according to claim 27, wherein said supporting means comprise a pair of fixing plates, which can be applied to respective mutually opposite side walls of said tray, each one of said plates supporting rotatably a pair of said telescopic stems, for transition from said first arrangement to said second arrangement, and vice versa.

29. The portable container according to claim 17, wherein said tray has a plurality of raised portions, which are distributed along an internal surface of said base surface, to form respective seats for corresponding partitions that can be inserted in said tray.

30. An accessory for containers comprising at least one shell, which delimits an internal compartment for accommodating a plurality of objects, and comprising a tray, provided with means for detachable coupling to the shell, for a stable arrangement of said tray within the internal compartment and for extraction thereof, with consequent practical and easy movement of objects contained in said tray even at a distance from the shell.
